(19) United States
(12) Patent Application Publication
(10) Pub. No.: US 2017/0210292 A1
(43) Pub. Date: Jul. 27, 2017

(54) Back-Up Panorama Camera

(71) Applicant: Jonathan Allen, Mohnton, PA (US)

(72) Inventor: Jonathan Allen, Mohnton, PA (US)

(73) Assignee: Jonathan Allen, Mohnton, PA (US)

(21) Appl. No.: 15/007,145

(22) Filed: Jan. 26, 2016

(51) Int. Cl. B60Q 9/00; B60R 1/00

(52) U.S. Cl. CPC B60Q 9/005; B60R 1/00; B60R 2300/802; B60R 2300/806

(57) ABSTRACT

The Back-up Panorama Camera is a unique back up camera with three cameras mounted on a license plate frame and a power hinge to swing the license plate out behind the vehicle. What is new about this invention is that it utilizes the license plate in order to get a better view behind the car. It also uses three cameras in close proximity to each other in order to see absolutely everything behind the car. This will help drivers avoid accidents in busy parking lots and keep pedestrians safe.

### BACKGROUND OF INVENTION

This invention has to do with the automotive field. Mainly it is for car manufacturers and aftermarket manufactures. The problem this invention solves is preventing cars from hitting other cars, people, or animals while backing up out of a crowded parking lot. The only other invention like it is the back-up camera. Where the back-up camera falls short is it cannot see directly sideways which creates another blind spot. Inside this blind spot can be a person, animal, or another car.

### BRIEF SUMMARY OF THE INVENTION

This invention is meant to prevent accidents in crowded parking lots when backing up in a car. Whether the car is large or small this will let drivers be more aware of what is around them in spots they could never see. The way it solves this problem is by showing the driver everything directly behind and to the sides of the driver.

### BRIEF DESCRIPTION OF THE SEVERAL VIEWS OF THE DRAWING

FIG. 1 This figure shows the extended and contracted form of the backup panorama camera. The contracted view is how it looks when not activated and operating as a normal license plate. The extended view is how it looks when activated. It swings outward to give ample coverage of the area behind the car.

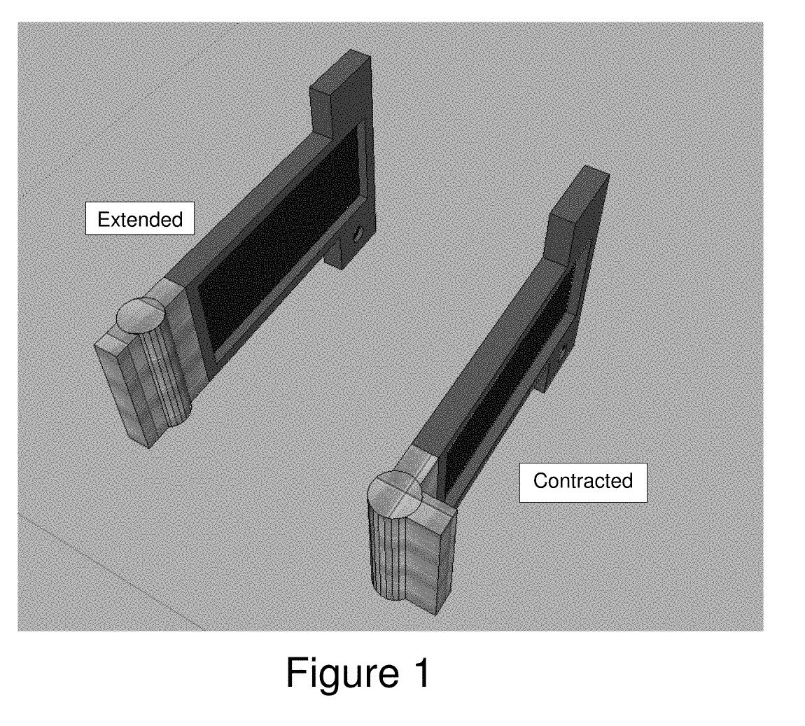

FIG. 2 is the outward facing side of the license plate. It shows the camera, frame, and power hinge. The camera is a standard small backup camera with a fisheye lens which is used in most backup cameras. The frame is a plastic two piece rectangle that tightens together over the license plate with screws. The power hinge is a circular joint that turns from a 90 degree angle(when not activated) to a 180 degree angle(when activated).

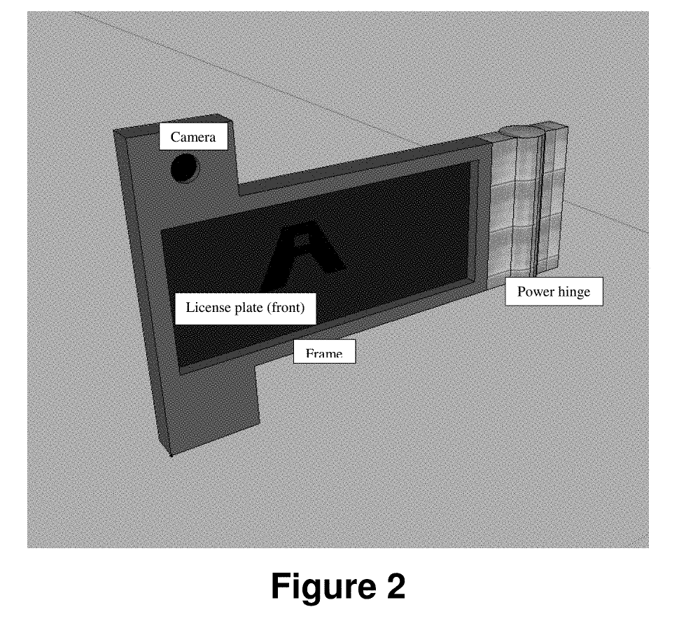

FIG. 3 shows the backside of the backup panorama camera. On this side is the other camera to show the opposite side of the car.

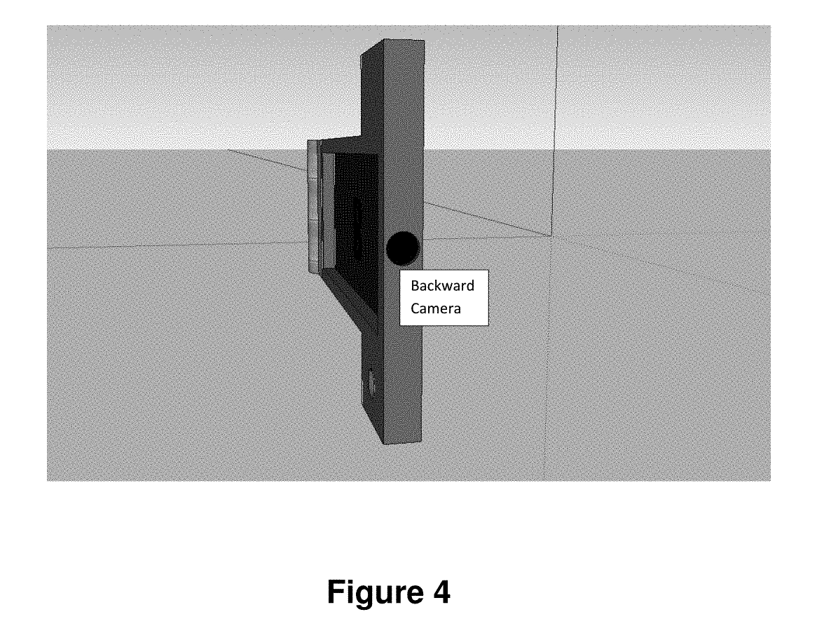

FIG. 4 shows the backward facing camera that looks straight back behind the car.

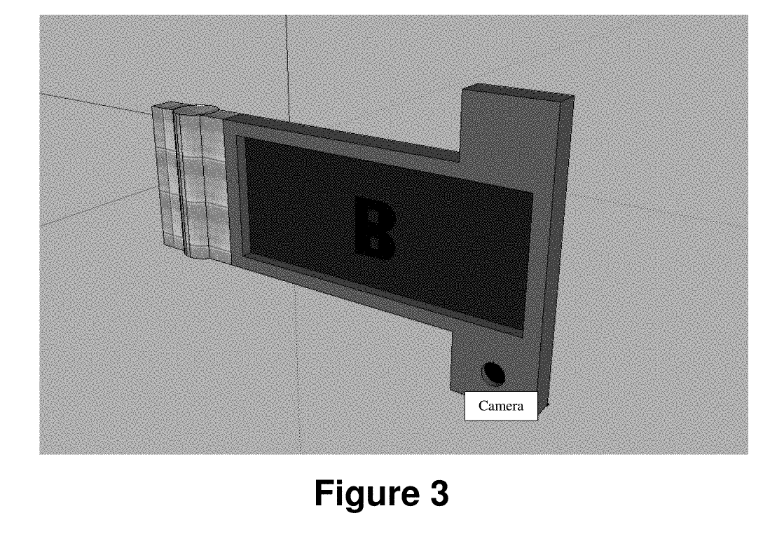

### DETAILED DESCRIPTION OF THE INVENTION

The back-up panorama camera has three main components. These components are the plastic frame, the power hinge, and the three cameras. The plastic frame is made of strong plastic. It screws down over the license plate and connects to the power hinge. The power hinge latches to the trunk. There are three cameras inside of the frame. There is one camera on the front and back of the frame and another on the side. The wires all go through the plastic frame and are activated when the car is in reverse. The power hinge does not activate until a button for it is pressed that is on the dashboard. This way use of it is selective. It should be used whenever someone is not able to see behind them to the sides while backing out of parking spaces. This is a problem because people often cannot see to the sides behind them when there are larger vehicles to either side of the car or in a busy parking lot. When the power hinge is not in use only the outward facing camera activates while in reverse. This function is automatic. When the user activates it by, first, being in reverse. Next, they must press the button on the dashboard to activate the power hinge. When that is activated, the other two cameras also turn on. On the screen inside the vehicle, which must already be a part of the vehicle, the display will show the images from each camera. Each camera angle will appear in its own section of the screen. When the car is put back into drive the power hinge automatically retracts and turns off.

1. This invention will make it easier to get out of tight parking spaces in busy areas; it will save lives by providing better sight lines to drivers that are impossible to see therefore preventing collisions with other vehicles or people.

2. It will display three camera angles onto the one screen in a vehicle; it operates on a closed circuit; it is a frame that fits around the license plate and bolts onto the trunk by the power hinge.

3. It can rotate outward at 90 degrees at the touch of a button on the dashboard; it can let the driver see backwards and behind to the left and right of the car; it can replace average backup cameras and save many companies a lot of money while keeping people safe.
